(19) United States
(12) Patent Application Publication
(10) Pub. No.: US 2005/0282102 A1
(43) Pub. Date: Dec. 22, 2005

(54) Kit for use by dental professionals

(75) Inventor: Jimmie Kert, Vaerloese (DK)

Correspondence Address: CROCKETT & CROCKETT, 24012 CALLE DE LA PLATA, SUITE 400, LAGUNA HILLS, CA, 92653, US

(73) Assignee: CMS-Dental Aps, Copenhagen K. (DK)

(21) Appl. No.: 10/870,009

(22) Filed: Jun. 16, 2004

(51) Int. Cl. A61C 3/00

(52) U.S. Cl. 433/29

(57) ABSTRACT

A kit for use by dental professionals comprising a handle part with a proximal end and a distal end and a plurality of user interchangeable electrically operated heads to be attached to the distal end of said handle part. The handle part provides power for any of the heads fitted thereto.

### FIELD OF THE INVENTIONS

The present inventions is in the field of medical devices used by dental professionals. In particular, the inventions relate to devices with light sources that are used in the oral cavity to cure photocurable dental compositions or to diagnose tissues in the oral cavity.

### BACKGROUND

During the last couple of years, various new curing lights have been introduced on the market. First came the so-called plasma arc lights, then the first-generation LEDs, and recently the second-generation LEDs. Second-generation LEDs are light-emitting diode lights based on the extremely powerful 1 and 5 watt LED bulbs. One watt LED bulbs are used in lights where the diode is placed at the tip of the light, close to the to be cured composition in the tooth. An exemplary one watt LED curing light is disclosed in U.S. Ser. No. 10/170,037 assigned to CMS-Dental ApS. Five watt diodes are used in curing lights produced as a handpiece where a light guide transmits the light from the diode to the surface of the tooth.

Diagnosis of fractures causing discomfort or pain is an increasing clinical problem. Depending on the nature of the fracture, the prognosis of the tooth may vary from good to very poor. Early detection may be of vital importance, in which case a crown or a suitable adhesive technique may be applied.

In many cases, early detection of interproximal caries can be difficult with hand instruments. Radiographic diagnosis will often be an efficient aid, but should be used sparingly.

However, a transilluminator will often be sufficient to reveal an interproximal “shadow”. Even then, some caries may not be visible with transillumination.

In endodontic therapy it can often be difficult to locate the access opening for molar root canals. A transilluminator positioned at right angles to the axis of the tooth, level with the floor of the pulp chamber, will often reveal their location. Even previously obturated canals will often display their original access opening.

Diagnostic lights with a white light source been used for transillumination of the dentition. A curved light guide is used. Caries can be seen with the naked eye when transilluminating the dentition with the correct light intensity. Fractures and root canal access openings can be rendered visible by the same method. Also, less common conditions such as air trapped underneath inlays or veneers are clearly visible with transillumination.

Soft tissue diagnostics is a thorough inspection of the mucous membrane of the oral cavity. Cancer of the oral cavity—the vast majority of which being planocellular carcinoma—is the fifth most common form of cancer in the western world at approx. 3% of all forms. This condition is typically found in adults past 40. It is most common in men, but is increasingly common in both genders. 75% of the cases are attributed to predisposing factors such as tobacco and alcohol. The combination of the two seem to have a synergistic effect. However, 25% of the cases seem to lack any provoking factors.

Primary dental care professionals such as dentists and dental hygienists have the first opportunity to spot any “suspicious” conditions of the mucous membrane. Early detection is critical.

A chemiluminescent light, with or without a pre-treatment of the tissue with an acidic composition that enhances visualization of the tissue has been used in the past for illuminating the oral cavity for soft tissue diagnosis. The single use pen-shaped chemiluminescent light is however relatively expensive.

The environment of a dental professional comprises, apart from the three different types of lights described above, a large number of other tools. It would therefore be desirable to reduce the number of tools.

### SUMMARY

The inventions described below provide a kit for use in the oral cavity, comprising a handle part with a proximal end and a distal end and a plurality of user interchangeable electrically operated heads to be attached to the distal end of the handle part; the handle part provides power for any of the heads fitted thereto. Different heads can perform a variety of functions in the oral cavity, such as curing dental compositions, transilluminating dentition, illuminating the oral cavity for soft tissue examination.

The kit may comprise at least one head provided with an LED. The kit may further comprise at least one user interchangeable light guide for attachment to said head provided with an LED.

### BRIEF DESCRIPTION OF THE DRAWINGS

In the following detailed portion of the present description, the inventions will be explained in more detail with reference to the exemplary embodiments shown in the drawings, in which

FIG. 1 is a side view of an unassembled kit for use in the oral cavity,

FIG. 2 is a side view of an assembled tool in a first configuration,

FIG. 3 is a side view of an assembled tool in a second configuration,

FIG. 4 is a side view of an assembled tool in a third configuration,

FIG. 5 is a side view of an assembled tool in a third configuration,

FIG. 6 is a cross-sectional view on the assembled tool, and

FIG. 7 is a perspective view of the assembled tool of FIG. 5.

### DETAILED DESCRIPTION

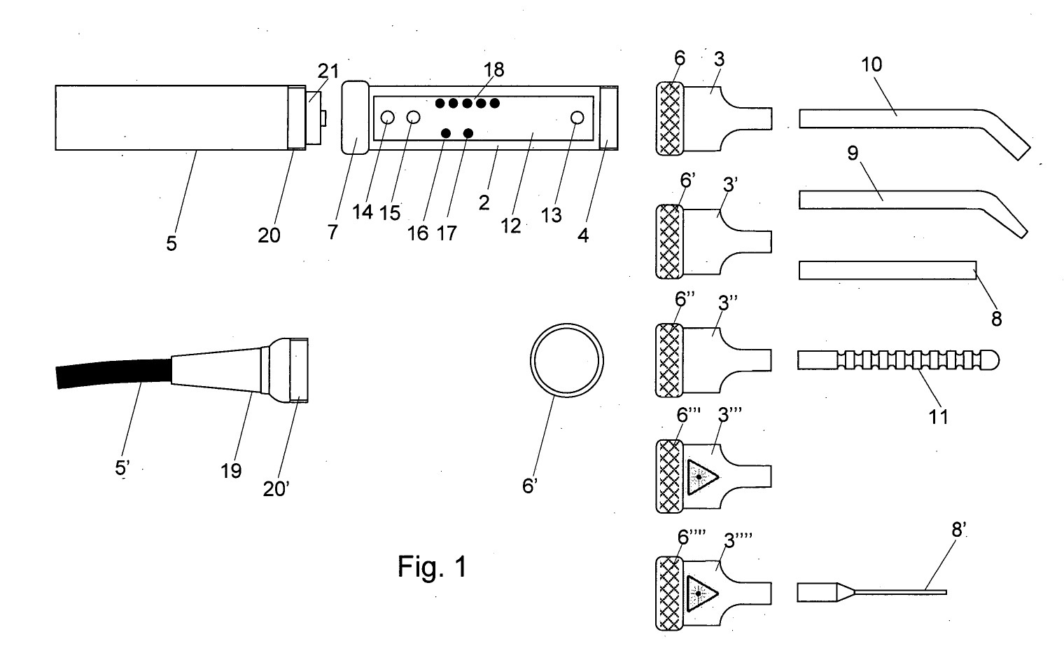

Reference will be made first to FIG. 1, which is a side view on the components of a kit 1 for use by a dental professional. The kit 1 comprises a handle part that is formed by a hollow tubular body 2. The tubular body can be made of a metal, preferably a metal that is strong, light and has a high heat transport coefficient, such as an aluminum alloy.

The handle part 2 has a proximal end provided with a threaded annular retainer ring 7 that serves to engage the thread 20 or 20′ of a battery section 5 or a power supply cord 19, respectively. Electrical contacts (not shown) connect the handle part 2 electrically to the battery section 5 or power cord 5′, respectively.

The battery section 5 is a tubular body with an open and a closed bottom that receives a rechargeable battery 21. The open end of the battery unit 5 is provided with a thread 20 that engages the annular retainer ring 7. The battery may be sealed into the battery section, and the battery section may be fixed to (or made integrally with) the handle part, in which case the battery may be charged through and inductive charging system.

The power cord 5′ is provided with an adapter unit 19 provided with the necessary electrical contacts/connectors (not shown) and a threaded end 20′ that engages the annular retainer ring 7. The power cord 5′ delivers electrical power from an external power source, such as the dental unit (not shown). The handle part 2 with the power cord 5′ attached thereto is sized and configured to be received by a dental hand piece holding tray (not shown) associated with the dental unit. Thus, the tool can form an integral part of the dental unit.

The kit comprises a plurality of interchangeable diode heads 3, 3′, 3′″, 3′″, 3″″. A rotatable retainer ring 6 is part of the heads 3, 3′, 3″, 3′″, 3″″. The internally threaded retainer ring 6 engages the thread 4 on the distal end of the handle part 2 to connect the head 3, 3′, 3″, 3′″, 3″″ to the handle part 2. Any other releasable attachment means, such as bayonet fittings, elastic O-rings assemblies, detents, spring clips, etc. may be used to connect the light guides in a manner that can be accomplished easily while treating a patient. Complementary connectors (not shown) on the head 3, 3′, 3″, 3′″, 3″″ and on the handle part 2 establish an electrical connection between the head 2 and the handle part.

In the shown embodiment the kit comprises five different types of diode heads. A kit could though also have only two or more than five heads. Preferably, though, kits will include two or more groups of heads, including a first group of heads having one or more LED's of a first type and a second group of heads having one or more LED's of a second type.

Head 3 contains a diode emitting light in the blue to violet spectrum in the range from 450 to 490 nm. The light emitted by this diode is suitable for curing materials which are photosensitive within this range, typically camphorquinone. Head 3 is the standard solution for composite curing.

Head 3′ contains diode emitting light in the blue to violet spectrum in the range from 420 to 460 nm. The light emitted by this diode is suitable for curing materials which are sensitive to lower wavelength radiation such as phenyl-propanedione.

Head 3″ contains a diode emitting white light for diagnostic purposes. The light emitted by this head is—in combination with the appropriate light guide—suitable for oral mucosa diagnostics and hard tissue diagnostics (transillumination).

Head 3′″ contains a continuous wave diode laser emitting light with a wavelength of about 700 to 900 nanometer (typically between 800 and 840 nanometer) and an output effect of about 100 to 500 mW, typically about 150 mW, i.e. an international class 3b laser. The light emitted by this head is—in combination with the appropriate light guide—suitable for Low Level Laser Therapy.

Head 3″″ contains a continuous wave diode laser emitting infrared light with a wavelength of about 700 to 900 nanometer (typically about 800 to 840 nanometer) and an output effect of about 1500 to 7000, mW, i.e. an international class 4 laser. The light emitted by this head is—in combination with the appropriate light guide—used as a chirurgical laser for hemostasis and for cutting.

The heads are interchangeable. Should the dental professional i.e. change to a composite material that uses a different wavelength for curing, the present head can be interchanged with one with a matching wavelength.

The kit comprises in the present embodiment five different light guides. The kit could though include any other number of light guides.

A light guide 8 is a straight glass light guide with a large tip for a large working area. This light guide can be autoclaved and re-used for many treatments.

A light guide 9 is a disposable curved acrylic light guide with a small tip for high light concentrations and deep light penetration.

A light guide 10 is a disposable curved acrylic glass light guide with a large tip for high light concentrations and deep light penetration.

The ability to transmit light of the disposable acrylic light guides substantially equals that of glass light guides.

A light guide 11 is a polycarbonate straight light guide emitting diffuse light along a substantial part of its length. The complete surface of the light guide 11 is roughened with indentations to extract light from the light guide, except for the proximal end that is received in head 3″. Light guide 11 according to the present embodiment is made by injection molding acrylic material. The inside of the mould is rough to produce light guides 11 with a rough outer surface. The light extracted from the rough surface of the light guide is diffuse and shadow free. A plurality of annular grooves is provided along the length of the part of the light guide that extends from the head 3″ to increase the surface area from which light is extracted and to maximize scattering of the light. The tip at the free distal end of the light guide 11 has a rounded shape for minimizing the risk of hurting or injuring the mucous membrane in the oral cavity. The rounded tip is also provided with a roughened surface and emits diffuse light. The length of the part of the light guide that extends from the head 3″ is adapted to be inserted in the oral cavity of a patient. Typically a length of 50 to 80 cm, preferably 65 to 70 cm corresponds well to the average size of the oral cavity.

Light guide 8′ has a optical fiber tip for delivering highly concentrated and focused infrared irradiation in surgical procedures.

The light guides are interchangeably received in a bore in the heads. Two elastic O-rings received in annular grooves in the bore secure the light, guide in a releasable manner. Any other releasable attachment means, such as bayonet fittings, screw threads, detents, spring clips, etc. may be used to connect the light guides in a manner that can be accomplished easily while treating a patient.

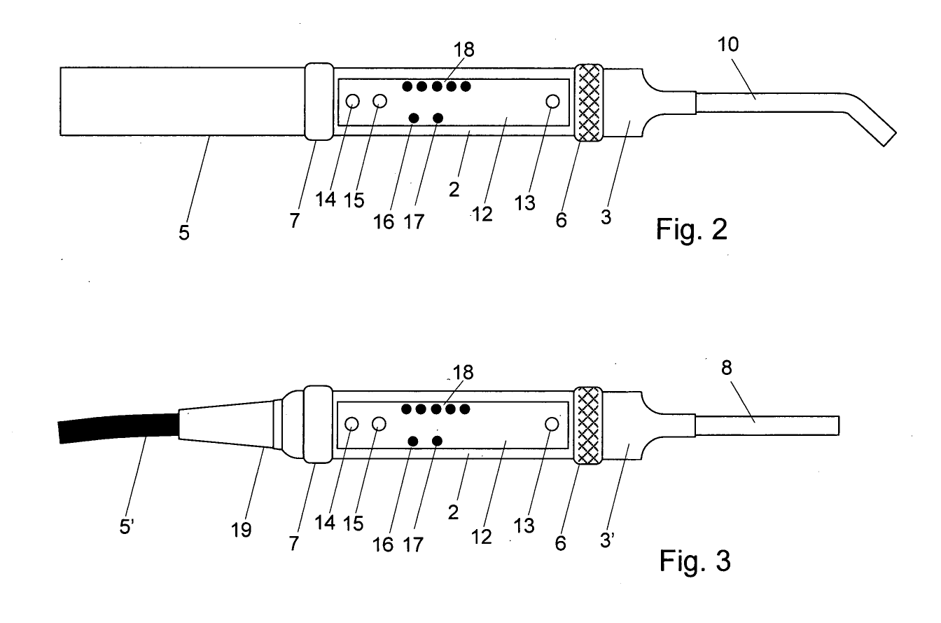

FIG. 2. illustrates an assembled tool with the battery unit 5, head 3 and light guide 10 in place. The tool is now ready to be used by a dental professional for curing a camphorquinone based composition in a patient's tooth. If necessary the light guide 10 can be interchanged by the user with light guide 8 or light guide 10.

FIG. 3 illustrates an assembled apparatus with the power cord 5′, head 3′ and light guide 8 in place. The apparatus is now ready to be used by a dental professional for curing a phenyl-propanedione based composition in a patient's tooth. If necessary, the light guide 8 can be interchanged by the user with light guide 9 or light guide 10.

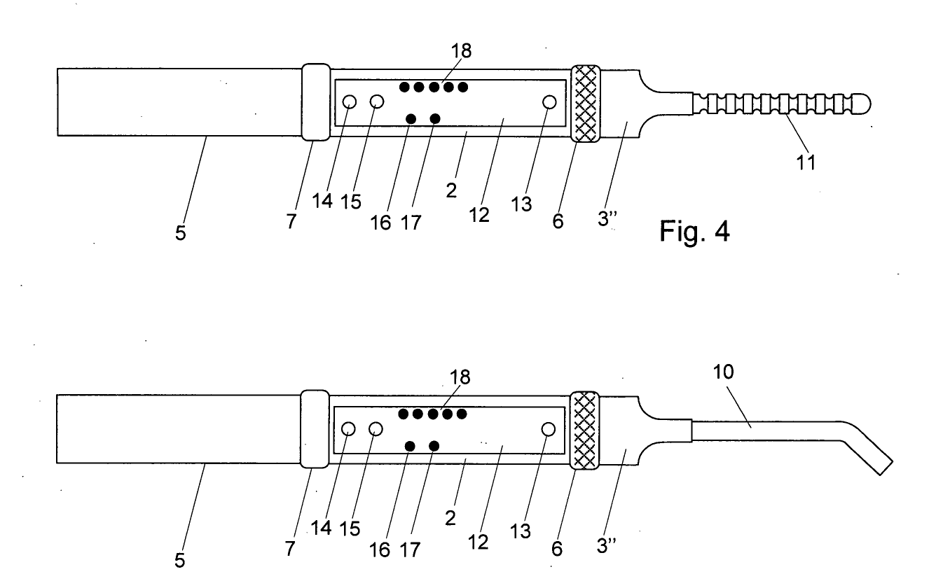

FIG. 4 illustrates an assembled apparatus with the battery unit 5, head 3″ and light guide 11 in place. The apparatus is now ready to be used by a dental professional for soft tissue examination, i.e. a visual inspection of the mucous membrane inside the oral cavity.

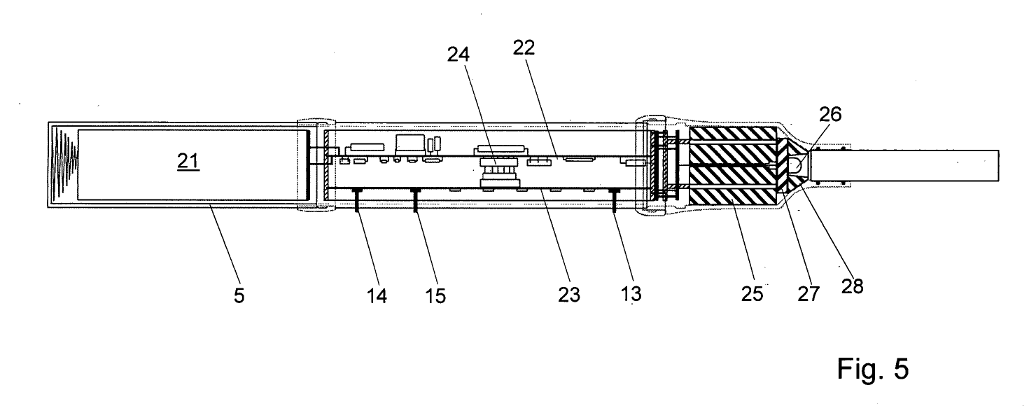

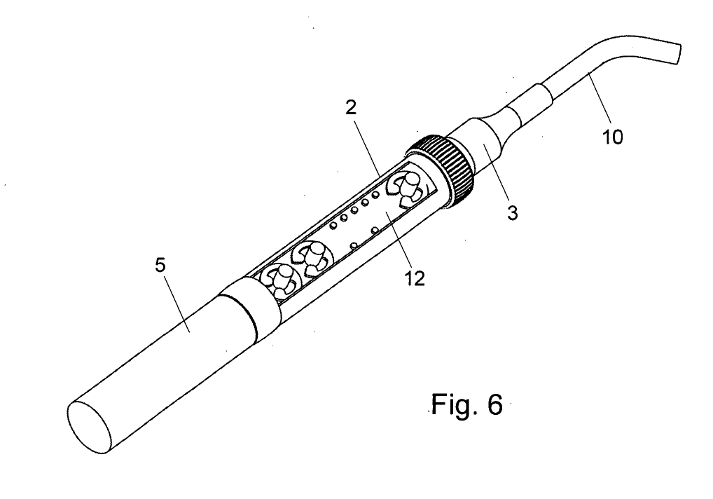

FIG. 5 illustrates an assembled apparatus with the battery unit 5, head 3″ and light guide 10 in place. The apparatus is now ready to be used by a dental professional for hard tissue examination, i.e. a visual inspection of the dentition by transillumination.

The handle part 2 contains a microprocessor based programmable control unit (not shown). Software controls the functions of the apparatus. There are two main menus stored in the control unit, each comprising a number of programs. Menu A—primarily used for curing—contains five different fixed intervals and fixed light intensities. Menu B—used for diagnostic purposes—contains five programs with continuous light: Two with predetermined light intensity and three with variable light intensity. The last three programs are available for storing the user's preferred settings. This is particularly important for the diagnostic use of the instrument.

The handle part 2 is provided with a control panel 12. The control panel 12 comprises an on/off button 13, a menu down button 14 and a menu up button 15. The control panel is provided with an LED indicator 17 indicating the active/non-active state an LED battery indicator 16 and an array of five LEDS 18 for indicating the selected program.

The programs are selected by pressing the menu down button 14 or the menu up button 15. Menu B contains programs with continuous light and a combination of optional and preset light intensities. These are selected by pressing the menu up/menu down buttons. Toggling between the two menus A and B—is done by pressing the menu up button and menu down button simultaneously. If there are more than two menus these are arranged in an endless loop manner that can be scrolled through by simultaneous activation of the menu up button and menu down button.

There are three programs with full intensity. Furthermore, there are two programs with a four second soft-start, followed by full intensity light. Several studies have indicated that a light-cured composite material should initially be cured at low intensity for a longer duration. With the present apparatus the intensity can be adjusted in 20 steps between off and full intensity.

According to a preferred embodiment the heads 3, 3′, 3″, 3′″, 3″″ comprise identification means such allowing the control unit to identify a head mounted to the handle part. The control unit preselects the most appropriate program. If needed any of the other programs are still accessible via the menu structure. It is also possible to preselected the preferred program for each head. General circuitry such as different resistor values, or more advance integrated circuitry can be used for identification of the heads.

FIG. 5 shows the assemble tool in cross-section to illustrate the inner components of the tool. The rechargeable battery 5 is urged toward the handle part 2 by a spring at the bottom of the battery section. The handle part 2 contains an inner first printed circuit board 22 on which a microprocessor that controls the operation of the tool is mounted. Also a DC-DC step up converter that increases the battery voltage of about 4V to about 8V is mounted on the inner print circuit board 22.

A second printed circuit board 23 is placed just below the control panel 12. The indication LEDs 16,17,18 and the buttons 13,14,15 are mounted on the second printed circuit board 23. A connector 24 connects the two printed circuit boards.

The heads 3, 3′, 3″, 3′″, 3″″ contain a metal cooling block 25 that tightly fits in the head, and has therefore direct metallic contact with the head. The LED is mounted on a metal plate 27 that is attached to the cooling block 25 by a thin layer of cooling paste (the cooling paste cannot be seen). The LED is received in a reflector 28 that is preferably also made of metal. High output LED create a large amount of heat. When this heat is not transported away efficiently, the LED gets too hot and its performance can drop up to 30%. The large cooling block and continuous metallic connection between the LED and the head 3, 3, 3″, 3′″, 3″″ itself, provides optimum cooling for the LED. The head 3, 3′, 3″, 3′″, 3″″ is preferably made of an aluminum alloy, as are the handle part 2 and the battery section. The complete housing of the tool thus contributes in forming a large heat sink that cools the LED.

A thorough examination of the oral cavity is best done with a soft diffused light which eliminates any shadows and reflections. Equipped with the light guide 11, the apparatus emits this special light. In addition, an extended examination may be used where the patient rinses his/her mouth with a 1% acetic acid solution. The acidic solution is an orange-flavored 1% acetic acid solution. The solution is so weak that the acid does not harm the enamel. The mouth rinse temporarily dehydrates the oral mucosa, which makes any early leukoplakia more visible. This phenomenon occurs because abnormal cells tend to have a higher nucleus/cytoplasm ratio, and the dehydration will change the reflection of the light from the mucous membrane so that such cells become visible as so-called “aceto-white lesions”. In examination of the mucous membrane the dental professional looks for wounds, leukoplakia, changes of color, etc. in the mucous membrane.

Light guide 11 emits omni-directional diffuse light to provide for shadow free illumination of the oral cavity. The suitable intensity of the light is selected using the menu down and menu up buttons.

Hard Tissue Diagnostics

The kit can also be used for transillumination of the dentition. In this case, a curved light guide is used, either 4 or 8 mm, depending on the practical circumstances, and the desired light intensity. At the correct light intensity, the dentition is simply transilluminated and caries can be seen with the naked eye. Also fractures and root canal access openings which are difficult to detect by any other method can be seen. Also, less common conditions such as air trapped underneath inlays or veneers are clearly visible with transillumination.

Low Level Laser Treatment

With the head 3′″ mounted to the kit can be used for low level laser treatment (LLLT). A dentist will typically apply LLLT for:

Reducing Post—Surgical Swelling and Pain:
extractions,
any surgery,
endodontics, and
(deep) scaling,

Promoting Healing, Alleviating Pain:
herpes/aphtae,
surgery, and
extractions,

Pain Relief:
dentin hypersensitivity,
pulp hyperaemia, and
facial pain/trigeminal neuralgia.

Pain Relief and Muscle Relaxation:
TMJ problems.

Also stomatitis, of the mouth associated with a severe primary condition such as AIDS, cancer with radiation therapy can be treated with head 3′″.

Surgery

With the head 3″″ mounted to the handle and a fiber optic light guide the kit can be used for laser surgical operations, such as homeostasis and soft tissue cutting.

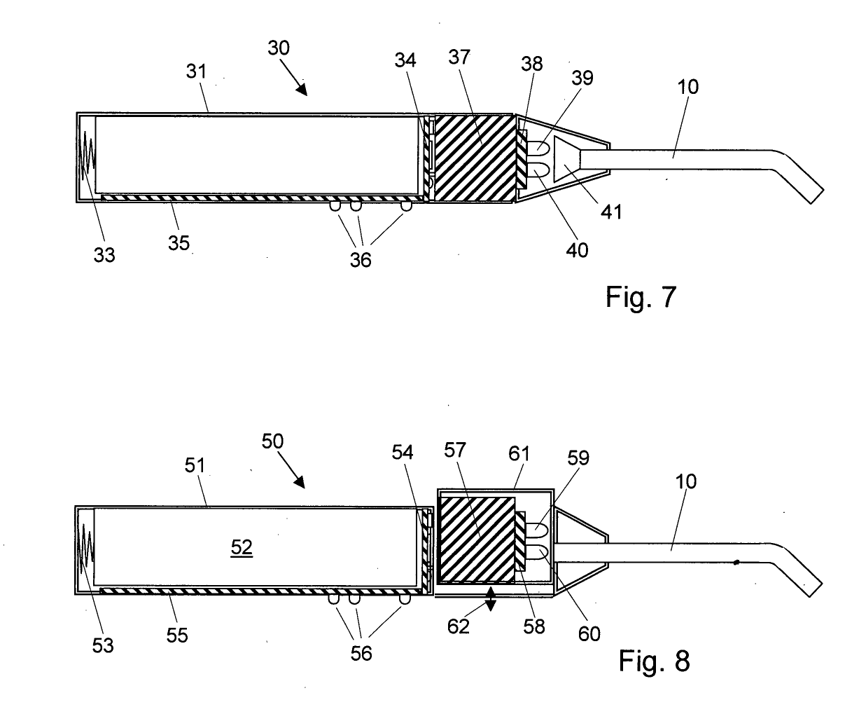

FIG. 7 illustrates another preferred embodiment of the inventions. A tool 30 for use by a dental professional comprises a tubular housing 31, containing a rechargeable battery 32 that is urged by a spring 33 in contact with a first printed circuit board 34 on which a microprocessor and a DC-DC step-up converter are mounted (not shown). On/off and menu up/down buttons 36 and a number of indication LEDs (not shown) are mounted on a second printed circuit board 35 that is received in the housing 31. A metal cooling block 37 is tightly fitted into the preferably metal housing 31. Two LEDS 39,40 are mounted on a metal plate 39. The metal plate 39 is attached with a thin layer of cooling paste to the cooling block 37. LED 39 emits light in the blue to violet spectrum for curing a photocurable dental composition. LED 40 emits substantially white light. LED 39 and LED 40 can be alternately activated by the microprocessor under user control via buttons 36. A conical light guide 41 collects the light from the active LED. The light then passes to a light guide 10. Light guide 10 can be exchanged with light guides 8,9 or 11. Tool 30 can be used for curing dental compositions when LED 39 is active and any of the light guides 8,9,10 are mounted. Tool 30 can be used for hard tissue diagnostics when LED 40 is active and any of the light guides 8,9,10 is mounted. Tool 30 can be used for hard tissue diagnostics when LED 40 is active and the light guide 11 is mounted.

FIG. 8 illustrates another preferred embodiment of the inventions. A tool 50 for use by a dental professional comprises a tubular housing 51, containing a rechargeable battery 52 that is urged by a spring 53 in contact with a first printed circuit board 54 on which a microprocessor and a DC-DC step-up converter are mounted (not shown). On/off and menu up/down buttons 56 and a number of indication LEDs (not shown) are mounted on a second printed circuit board 55 that is received in the housing 51. A metal cooling block 57 is tightly fitted into the preferably metal housing 51. Two LEDs 59,60 are mounted on a metal plate 59. The metal plate 59 is attached with a thin layer of cooling paste to the cooling block 57. LED 59 emits light in the blue to violet spectrum for curing a photocurable dental composition. LED 60 emits substantially white light. LED 59 and LED 60 can be alternately activated by the microprocessor under user control via buttons 56. The cooling block 57 with LEDs 59, 60 thereon is received in a housing part 61 that is movable between a first (shown) and second (not shown) positions as illustrated by arrow 62. In the first position LED 60 is aligned with the light guide and in this position LED 60 can be activated. In the second position (not shown) LED 59 is aligned with the light guide and in this position LED 59 can be activated. Light guide 10 can be exchanged with light guides 8,9 or 11. Tool 50 can be used for curing dental compositions when LED 59 is active and any of light guides 8,9,10 is mounted. Tool 50 can be used for hard tissue diagnostics when LED 60 is active and any of the light guides 8,9,10 are mounted. Tool 50 can be used for hard tissue diagnostics when LED 60 is active and the light guide 11 is mounted.

Although the present inventions have been described in detail for purpose of illustration, it is understood that such detail is solely for that purpose, and variations can be made therein by those skilled in the art without departing from the scope of the inventions.

1. A kit for use in the oral cavity, said kit comprises:
a handle part with a proximal end and a distal end; and
a plurality of user interchangeable electrically operated LED heads to be attached to the distal end of said handle part, each of said LED heads having one or more LED's disposed thereon and;
said handle part having electrical power connection means disposed on the distal end thereof, said electrical power connection means adapted for releasably mating with each of the LED heads and transmitting electrical power from the handle to the LED's mounted on the LED head;
power supply means operably connected to the handle part.

2. A kit according to claim 1, wherein said plurality of heads comprises at least two groups of heads, including a first group of heads having LED's of a first type and a second group of heads having LED's of a second type.

3. A kit according to claim 1, further comprising at least one user interchangeable light guide for attachment to at least one of the heads, where the light guide includes releasable attachment means for attaching to the light guide to the head.

4. A kit according to claim 1, comprising a head with an LED configured for emitting light suitable for curing a photocurable dental prosthesis material.

5. A kit according to claim 4, comprising a head with an LED with a peak in its wavelength spectrum between 450 and 500 nm rendering it suitable for curing compositions containing campherquinone.

6. A kit according to claim 4, comprising a head with an LED with a peak in its wavelength spectrum between 420 and 470 nm rendering it suitable for curing compositions containing phenyl-propanedione.

7. A kit according to claim 3, comprising light guides with differing tip diameters.

8. A kit according to claim 3, comprising light guides made from acryl.

9. A kit according to claim 3, comprising a head with an LED that emits substantially white light.

10. A kit according to claim 9, comprising light guides with differing tip diameters, said light guides preferably being made of an acrylic material.

11. A kit according to claim 9, comprising an elongate light guide that emits diffuse light along at least a part of its length.

12. A kit according to claim 3, comprising a head with an LED configured for emitting light suitable for Low Level Laser Treatment, such as pain treatment.

13. A kit according to claim 12, wherein said LED is a continuous wave diode laser emitting infrared light with a wavelength of about 700 to 900 nanometer, preferably about 800 to 840 nanometer and an output effect in the range of 100 to 500 mW.

14. A kit according to claim 3, comprising a chirurgical head with an LED configured for emitting light suitable for hemostasis and/or cutting soft tissue.

15. A kit according to claim 14, wherein said LED is a continuous wave diode laser emitting infrared light with a wavelength of about 700 to 900 nanometer, preferably about 800 to 840 nanometer and an output effect in the range of 2000 to 5000 mW.

16. A kit according to claim 1, wherein the handle part comprises a controller with separate menus for different heads.

17. A kit according to claim 16, wherein the menus contain programs including a plurality of programs with different fixed activation intervals.

18. A kit according to claim 16, wherein the menus contain programs with a plurality of fixed activation intensity settings.

19. A kit according to claim 16, wherein the menus contain programs with variable user defined activation intensities.

20. A kit according to claim 16, wherein said handle comprises a user interface including two keys, and visual indication means for indicating the active one of a plurality of menus, whereby simultaneous activation of the two keys changes the selected menu in an endless loop manner.

21. A kit according to claim 20, wherein the said visual indication means further indicates the active of a plurality of programs under the selected menu, and individual activation any of the two keys changes the active program.

22. A kit according to claim 1, wherein the proximal end of the handle part comprises a connector that is configured to connect to either a power cable from an external power source or to a detachable battery section.

23. A kit according to claim 16, wherein the heads comprise identification means allowing the control unit to identify a head mounted to the handle part and to preselect the most appropriate programs.

24. An apparatus for use in the oral cavity comprising:
a handle part;
a light source emitting light in the blue to violet spectrum for curing a photocurable dental prosthesis which has been formed in a patient's tooth;
a light source emitting substantially white light for diagnostic purposes; and
a circuit for selectively activating either of the two light sources.

25. An apparatus according to claim 24, further comprising a single light guide.

26. An apparatus according to claim 24, further comprising a light guide connected via a tapered light concentrator.

27. An apparatus according to claim 24, wherein the light sources are alternatively movable behind the single light guide.

28. A kit for use in the oral cavity comprising a handle part, and a plurality of interchangeable heads for attachment to said handle part, said plurality of interchangeable heads including:
at least one head provided with an LED emitting light in the blue to violet spectrum for curing a photocurable dental prosthesis which has been formed in a patient's tooth,
at least one head provided with an LED emitting substantially white light for diagnostic purposes.

29. A kit according to claim 28, further comprising a preferably user interchangeable light guide for attachment to said head provided with the LED emitting substantially white light.

30. A kit according to claim 28, further comprising user interchangeable elongate light guide for attachment to said head provided with the LED emitting substantially white light, said interchangeable elongate light guide emitting diffuse light along at least a part of its length for illuminating the oral cavity.

31. A kit according to claim 28, further comprising a user interchangeable light guide for attachment to said head provided with the LED emitting light in the blue to violet spectrum.

32. A kit according to claim 28, wherein the LED that emits light in the blue to violet spectrum has a peak in its wavelength spectrum between 450 and 490 nm, the peak preferably being placed at about 470 nm.

33. A kit according to claim 28, wherein the LED that emits light in the blue to violet spectrum has a peak in its wavelength spectrum between 420 and 460 nm, the peak preferably being placed at about 440 nm.

34. A kit according to claim 28, further comprising a head with wave diode laser emitting infrared light.

35. An apparatus for illuminating the oral cavity of a patient, said apparatus comprising:
a handle part with a proximal end and a distal end;
an electrically powered substantially white light source; and
an elongated light guide disposed at the distal end of the handle part,
at least a substantial part of the length of the light guide emitting diffused light and being configured to be disposed within the oral cavity to illuminate the oral cavity without producing any substantial shadows.

36. An apparatus according to claim 35, wherein light guide is made of a light transmitting material and the diffuse light emitting part of the light guide has a rough outer surface.

37. An apparatus according to claim 36, wherein the outer surface is roughened with indentations.

38. An apparatus according to claim 35, wherein the light guide is provided with grooves, preferably annular grooves, to maximize scattering of the emitted light.

39. An apparatus according to claim 35, wherein said light guide is a disposable item that is releasably attached to the handle part.

40. An apparatus according to claim 35, wherein the light guide is made of acryl, preferably by injection molding.

41. An apparatus according to claim 35, wherein said diffuse light emitting part extends circumferentially around the light guide to produce omni-directional diffuse light.

42. An elongate light guide for illuminating the oral cavity of a patient, said light guide being made of light transmitting material and comprising a proximal end for connection to a light source, and a distal free end, the surface of at least a part of the length of said light guide has a rough outer surface to extract light from the light guide.

43. An elongate light guide according to claim 42, made of plastic material.

44. An elongate light guide according to claim 43, made by injection molding.

45. A light for use in the oral cavity comprising a handle part and at least one LED, the LED being cooled via a metallic cooling member connected to the housing of the handle part, the housing of the handle part being substantially completely made of metal.

46. A method for examining the mucous membrane of the oral cavity of a patient, comprising the steps of:
placing an electrically operated light with an elongated diffuse lighting element protruding from a handle part in the oral cavity of a patient;
shining said light on the mucous membrane; and
visually examining said tissue.

47. A method of inspecting the oral cavity of a patient comprising the step of illuminating the oral cavity of the patient without producing substantial shadows with an elongate light guide with diffuse light extraction along at least a part of its length.

48. A handle part of a device for use in the oral cavity, comprising a proximal end and a distal end, said distal end being configured to releasably attach electrically operated LED heads thereto, and said handle part comprising a controller unit for controlling power delivered to said LED heads in accordance with one of a plurality of programs, said LED heads comprising type identification means allowing the control unit to identify an LED head type mounted to the handle part and said controller being configured to automatically select a power control program suited for use with the type of LED head that is attached to the handle part.
